(19) United States
(12) Patent Application Publication
(10) Pub. No.: US 2013/0256305 A1
(43) Pub. Date: Oct. 3, 2013

(54) VARIABLE CAPACITY FUEL TANK

(71) Applicants: Daniel Schuller, Dubuque, IA (US); Scott C. McCartney, Bettendorf, IA (US); Karl G. Heine, Dubuque, IA (US); Joseph M. Montocchio, Dubuque, IA (US)

(72) Inventors: Daniel Schuller, Dubuque, IA (US); Scott C. McCartney, Bettendorf, IA (US); Karl G. Heine, Dubuque, IA (US); Joseph M. Montocchio, Dubuque, IA (US)

(21) Appl. No.: 13/438,523

(22) Filed: Apr. 3, 2012

(51) Int. Cl. B60K 15/077

(52) U.S. Cl. 220/86.1; 29/401.1

(57) ABSTRACT

A fuel tank with a substantially constant tank volume for which the fill capacity varies with the distance at which an end of a fill neck assembly enters the fuel tank. The fill neck assembly may include a fill neck and a fill neck insert.

### FIELD OF THE INVENTION

This invention relates to vehicular fuel tanks and, in particular, variable capacity vehicular fuel tanks.

### BACKGROUND OF THE INVENTION

Optimizing the empty weight of a work vehicle (in this example, an articulated dump truck (“ADT”) is a major concern for off road equipment as extra weight may mean unnecessary fuel consumption; optimization of fuel savings for a given amount of work is a highly prized feature on such a vehicle. Adding significant weight to vehicles powered by fossil fuels are the fuel tanks which are often filled to capacity. Thus, optimization of fuel savings might require limiting the capacity of a fuel tank which has been conventionally accomplished via: (1) tanks sized to a desired capacity, (2) tanks of complex design allowing the operator of the vehicle to measure the amount of fuel in the fuel tank and to stop at certain fuel volumes. Specially sized tanks add to the cost of manufacturing tanks as the tanks must be individually designed and produced for each vehicle model/size. Tanks of complex design are costly to produce yet still require a degree of monitoring by the vehicle operator to optimally fill them.

### SUMMARY OF THE INVENTION

A device and method are presented for varying the fuel capacity of a singular tank without extra monitoring by the vehicle operator. The device may be a filler neck assembly which may include a filler neck and a filler neck insert. The method may include the use of filler neck inserts of various lengths or a filler neck insert of adjustable lengths to adjust the fuel capacity of a singular tank by adjusting the length or depth of the filler neck assembly. Conventional fuel tanks do not utilize such filler neck inserts (see FIG. 6, “Related Art”).

### BRIEF DESCRIPTION OF THE DRAWINGS

FIG. 1 illustrates an exemplary embodiment of a work vehicle utilizing the invention;

FIG. 2 illustrates an exemplary embodiment of a fuel tank utilizing a first embodiment of the invention;

FIGS. 3a-3c illustrate schematics of the exemplary embodiment of FIG. 2 at various stages during a filling of the fuel tank;

FIG. 4 illustrates an exemplary embodiment of the fuel tank utilizing a second embodiment of the invention;

FIG. 5 illustrates an exemplary embodiment of the fuel tank utilizing a third embodiment of the invention; and

FIG. 6 illustrates an exemplary embodiment of a conventional fuel tank which is filled to capacity.

### DESCRIPTION OF THE PREFERRED EMBODIMENT

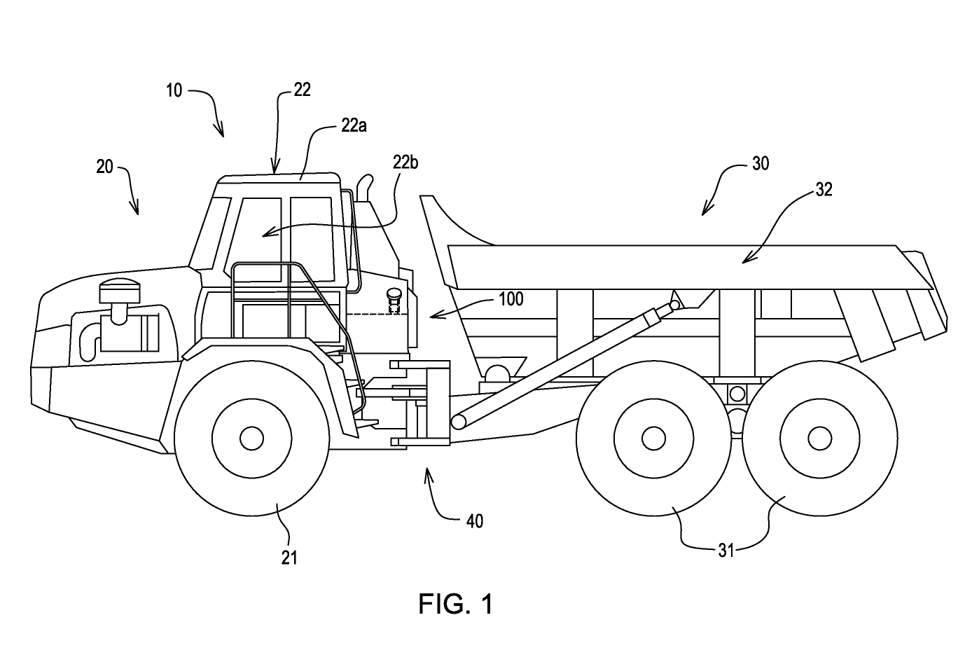

FIG. 1 illustrates an exemplary embodiment of a work vehicle 10 which could make use of the invention. The particular embodiment illustrated is an articulated dump truck (“ADT”) 10 employing an exemplary embodiment of the invention, i.e., the variable capacity fuel tank 100. This illustrated ADT 10 includes: a front portion 20 which may have a front chassis (not shown), an engine (not shown), ground engaging front wheels 21, a cab frame 22, a roof 22a, and a door 22b; and a rear portion 30 having a rear chassis (not shown), ground engaging rear wheels 31, and a dump body 32; and an articulation joint 40 allowing angular change between the front portion 20 and the rear portion 30.

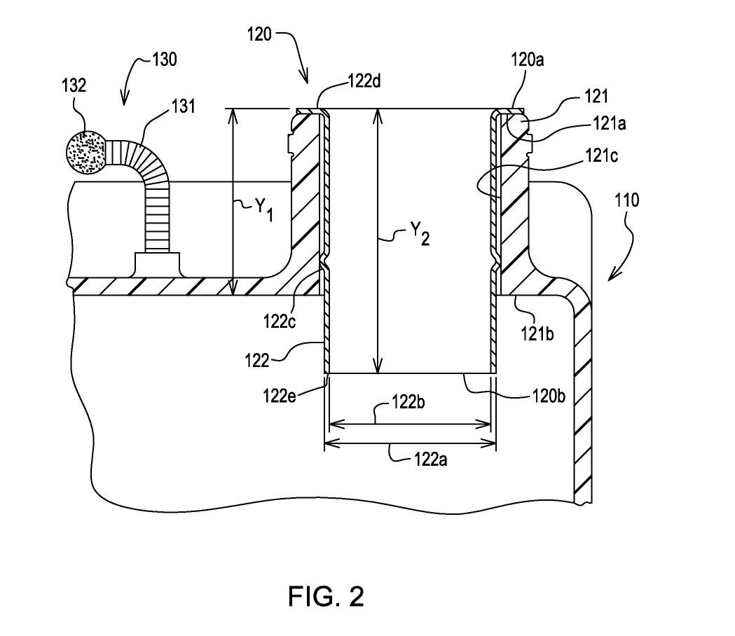

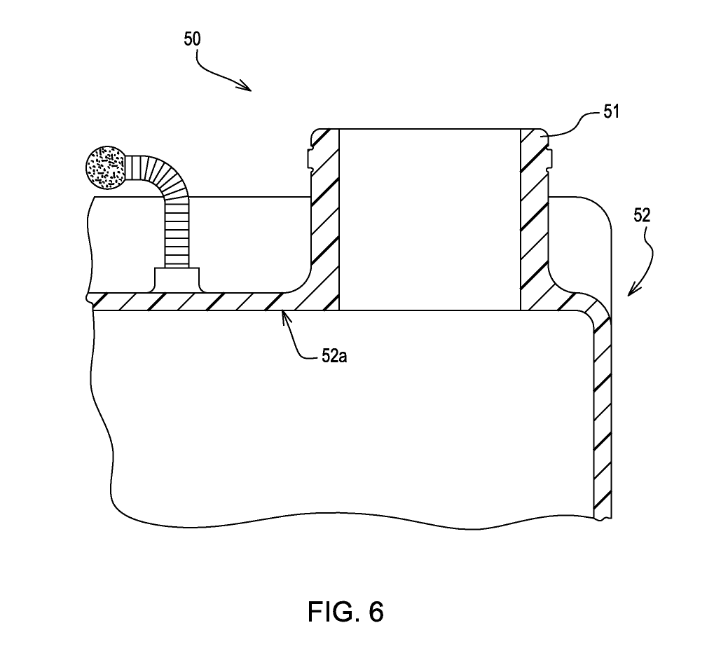

FIG. 2 illustrates an exemplary embodiment of the invention, i.e., the variable capacity fuel tank 100, which may include: a fuel tank storage body 110; and a filler neck assembly 120 having a filler neck assembly first end 120a and a filler neck assembly second end 120b. The filler neck assembly 120 may include a filler neck 121 having a filler neck first end 121a, a filler neck second end 121b and a filler neck inner diameter 121c; and a filler neck insert 122 having an insert outer diameter 122a, an insert inner diameter 122b and a diametrical insert bulge 122c. The filler neck assembly first and second ends 120a, 120b may be identical to insert first and second ends 122d, 122e. The variable capacity fuel tank 100 may also include a breather assembly 130 which may include a breather neck 131 and a breather 132. The breather neck 131 may be merely a hollow tube in communication with, and integral to, the fuel tank storage body 110 and the breather 132. The breather neck 131 may be considered to be sealed in a manner that allows free airflow only between the breather 132 and the fuel tank storage body 110. The filler neck 121 may be integral to the fuel tank storage body 110 as illustrated in FIG. 2. Some or all of the parts to the variable capacity fuel tank 100 may be plastic, steel or any other material capable of being formed and performing as described herein. Clamped to and, thus, sealing an outer diameter of one or both of the filler neck 121 and the filler neck insert 122 may be a conventional fill tube from an area of the vehicle at which the fuel is pumped in (not shown). To complement FIG. 2, FIG. 6 illustrates a conventional embodiment of the fuel tank 25, i.e., a fuel tank without the filler neck insert 122.

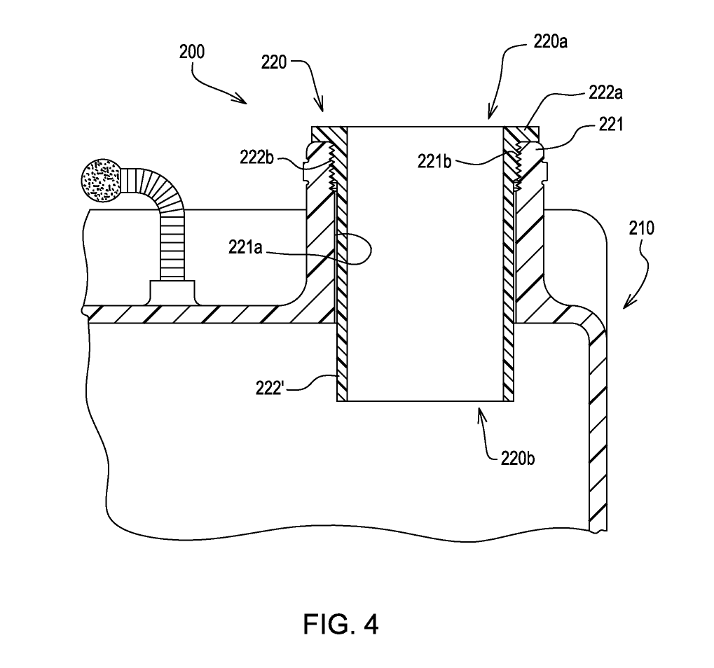

In the exemplary embodiment of FIG. 2, the diametrical bulge 122c in the filler neck insert 122 may serve as a seal between the filler neck insert 122 and the filler neck 121. In this exemplary embodiment, the filler neck assembly 120 may be held together by frictional forces via an interference fit between the bulge 122c and the filler neck inner diameter 121. However, the filler neck assembly 120 may be held together via sundry arrangements, including, but not limited to screw on arrangements as in the exemplary alternative filler neck assembly 220 of FIG. 4 and snap on arrangements as in the exemplary alternative filler neck assembly 320 of which could be used for filler neck assemblies having lengths that are adjustable without the necessity of insert change outs.

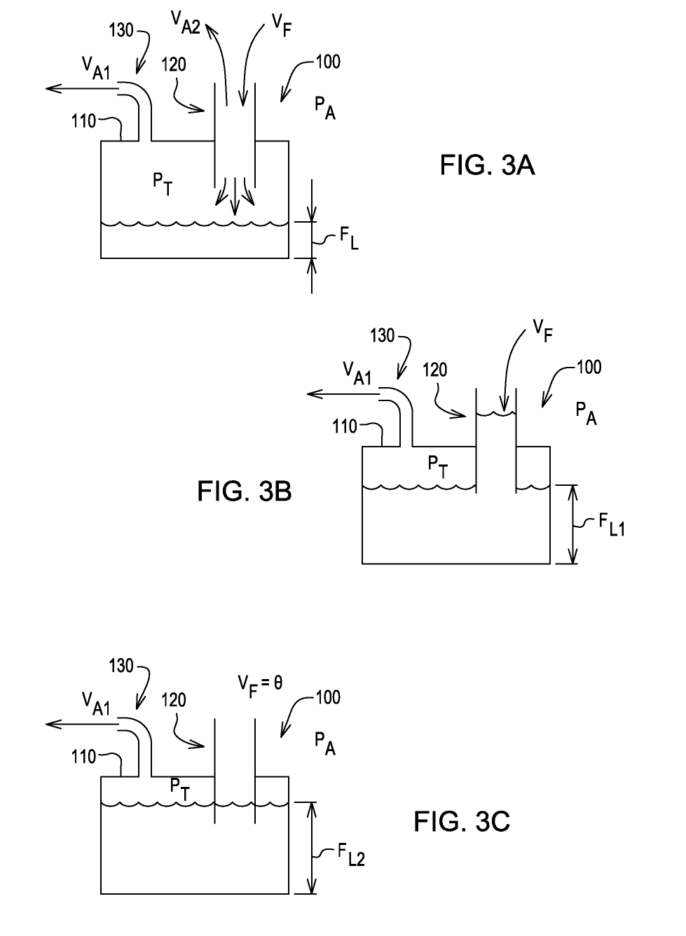

In the exemplary embodiments of FIGS. 2, 4 and 5 as well as schematic FIGS. 3a-3c, the breather 132 may be designed to allow a volumetric flow rate of air V_{A1} of approximately twice the rate of fuel injected into the engine per hour. The rate of injection in this particular example is 12 liters/hour, thus, rendering a maximum design volumetric flow rate for the breather (V_{bmax}) of approximately 24 liters per hour. A design of this sort optimizes the benefits of two features which are somewhat at odds with each other, those features being: (1) the ability of the tank to breathe and thus avoid pressure changes as fuel is injected into the engine; and (2) the ability to prevent or significantly reduce fuel contamination by blocking debris from entering the fuel tank 100. It should be noted here, that the storage body volume may be 634 liters in this exemplary embodiment and that, currently, this volume may be completely filled in approximately 20 minutes, the approximate conventional fill time for a storage body volume of this size. Thus, the filler neck may be designed to accommodate a V_{F} of at least 1921 liters/hour (the expected V_{F}), i.e., the fill rate required to transfer a fuel volume of 634 liters in 20 minutes.

The exemplary schematics of FIGS. 3a and 3b illustrate flow rates of air and fuel during a fueling of the vehicle. As illustrated in FIG. 3a, as the fuel tank 100 is being filled, i.e., when the fuel level in the tank 100 is below the second end 120b, V_{A1}+V_{A2}≧V_{F} and P_{A}≈P_{T}, where V_{A1} represents a volumetric rate for air flowing out of the fuel tank storage body 110 and through the breather 132, V_{A2} represents a volumetric rate for air flowing out of the fuel tank storage body 110 and through the filler neck assembly 120, V_{F} represents a volumetric rate for fuel flowing through the filler neck assembly 120 and into the fuel tank storage body 110, P_{A} represents atmospheric pressure, and P_{T} represents fuel tank pressure. Fuel may continue to freely flow into the tank storage body 110 as long as such a condition exists. However, once P_{T} exceeds P_{A}, the entrance of unpressurized fuel into the storage body 110 may be disallowed or significantly restricted.

However, once the fuel level in the storage body 110 has completely covered the second end 120b, any rate change in fuel volume in the tank V_{T} must be less than or equal to V_{bmax} or the tank pressure P_{T} may quickly exceed the atmospheric pressure P_{A} disallowing or significantly restricting the entrance of fuel into the tank from the filling process and filling the filler neck assembly 120 as well as the filler tube (not shown), if present, as illustrated in FIG. 3b. The following relationships apply once the second end is completely covered: V_{F}>V_{A1}; V_{A2}≈0; and P_{T}>P_{A}. To reiterate, air tends to not exit the tank storage body 110 through the filler neck assembly 120 as the second end 120b is closed. Therefore, pressure may build up in the tank storage body 110 as V_{F} exceeds V_{bmax} and, thus, V_{A1}. In this particular example, P_{T} quickly builds up as V_{F} far exceeds V_{A1} and, in fact, is approximately 80 times greater than V_{A1}. Once the fuel tops out the filler neck assembly 120 or the filler tube (not shown), if present, the operator may cease fueling the vehicle to avoid fuel waste via overflow and the fuel remaining in the filler neck and/or the filler tube 100a may gradually enter the storage body 110 as P_{T} gradually equalizes with P_{A} until the fuel level in the filler neck assembly 120 is approximately equal to the fuel level in the overall storage body 110 as illustrated in FIG. 3c. It should be noted here that the breather 132 may be designed to allow volumetric flow rates of less than or even greater than twice the rate of fuel injected per hour. As is apparent above, regardless of the capacity of the breather 132, P_{T} may rapidly build up in the tank storage body 110 once the second end 120b is covered to disallow or significantly restrict the flow of fuel to the tank storage body 110.

Below are some alternate embodiments of the invention. Although the specifics of these embodiments render clear differences, the principles of operation, i.e., varying tank capacity by varying a length of an inlet assembly remain the same.

In the exemplary screw on arrangement, i.e., the filler neck assembly 220 of FIG. 4, the filler neck 221 may include an internal thread 221b. As illustrated, the filler neck insert 222 may include an insert top 222a and a tube with a mating external thread 222b for the internal thread 221b. In such an arrangement, the filler neck insert 222 is inserted into the inner diameter 221a of the filler neck 221 and secured to the filler neck 221 by screwing the tube 222′ into the filler neck 221 and tightening via the internal and external threads 221b, 222b. The second filler neck assembly may include a first assembly end 220a and a second assembly end 220b. The capacities of the fuel tank storage body 210 and tank storage body 110 may remain equal when the location of their corresponding. The length of the filler neck assembly 220 may be adjusted by substituting filler neck inserts of different lengths in the assembly 220. This embodiment may also have a bulge (not shown) similar to the bulge 122a but, in this particular arrangement, the threads and/or the fit between the insert top 222a and the filler neck 221 may provide the necessary seal between the filler neck insert 222 and the filler neck 221. The capacities of the fuel tanks 200 and 100 may be equal when the locations of their respective filler neck second assembly ends 300b, 100b have equivalent locations.

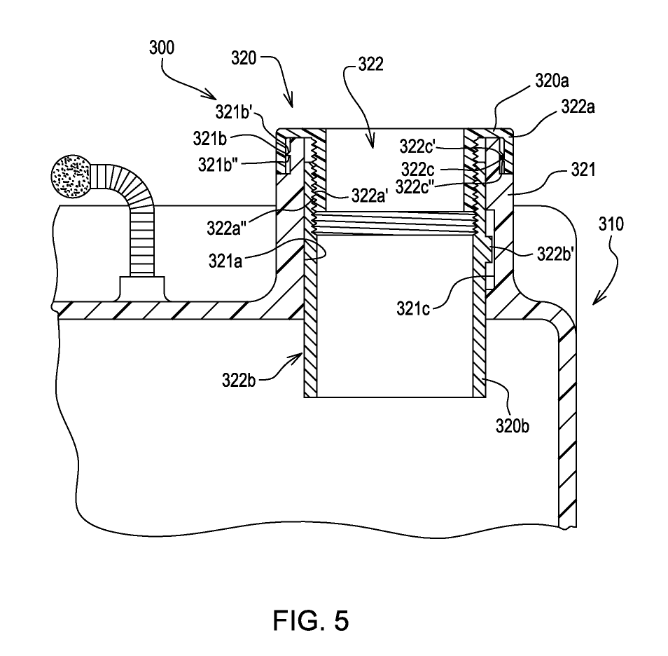

Note that the exemplary variable capacity fuel tank 300 of FIG. 5 includes an alternative filler neck assembly 320 having an assembly first end 320a an assembly second end 320b. As illustrated in FIG. 5, the filler neck assembly 320 may include an adjustable length filler neck insert 322 which may include: a cap or adjuster 322a with an insert locking tab 322c having a first tab side 322c′ and a second tab side 322c″, and an external thread 322a″and a tube 322b having a portion of its length threaded with internal thread 322a′ matching the external thread 322a″, and a vertical filler neck sliding tab 322b′. The filler neck 321 may include a ridge 321b having a first side 321b′ and a second side 321b″. In this snap on arrangement, the exemplary adjustable length filler neck insert 322 may be secured to the filler neck 321 by orienting and aligning it as illustrated and pushing filler neck insert 322 into the inner diameter 321a of the filler neck 321 until a resistance between the insert locking tab 322c and the ridge 321b is overcome and the insert locking tab 322c snaps into place on the second side of the ridge 321b. The length of the insert 322 is adjusted via a sliding of the tube 322b toward and away from the first filler neck assembly end 300a as the adjuster 322a is turned to the left or right and the insert sliding tab 322b′ slides within a filler neck groove 321c designed to inhibit rotation of the tube 322b within the filler neck assembly 300 when the adjuster 322a is being rotated. The capacities of the fuel tanks 300 and 100 may be equal when the locations of their respective filler neck second assembly ends 300b, 100b have equivalent locations.

As illustrated in FIG. 6, conventional tanks 50 may include only the filler neck 51 and not a filler neck insert (not shown). Thus, during a filling procedure, the storage body 52 may be filled to the top wall 52a.

Having described the preferred embodiment and a few alternatives, it will become apparent that various modifications can be made without departing from the scope of the invention as defined in the accompanying claims.

1. A variable capacity fuel tank assembly for a vehicle comprising:
a fuel tank comprising a fuel tank storage body for containing a fuel volume;
a fill neck having a fill neck first end facing an inside of the fuel tank storage body and a fill neck second end on an outside of the fuel tank storage body, the fill neck allowing fuel overflow past the fill neck second end at a first predetermined fuel volume; and
a fill neck insert having a length and capable of positioning within the fill neck to form a fill neck assembly, the fill neck assembly having a first assembly end and a second assembly end, the first assembly end located on the inside of the fuel tank storage body and at a greater distance from the fill neck second end than the fill neck first end, the fill neck assembly allowing fuel overflow past the fill neck second end at a second predetermined fuel volume.

2. The fuel tank assembly of claim 1, wherein the second predetermined fuel volume is smaller than the first predetermined fuel volume.

3. The fuel tank assembly of claim 1, wherein the fill neck second end is located at a first distance from the fuel storage tank body and the second assembly end is located at a second distance from the fuel storage tank body.

4. The fuel tank assembly of claim 3, wherein the second distance is greater than the first distance.

5. The fuel tank assembly of claim 1, wherein the airflow within an interface between the fill neck and the fill neck insert is approximately 0 liters per hour.

6. The fuel tank assembly of claim 1, wherein the length of the fill neck insert is adjustable.

7. The fuel tank assembly of claim 1, further including an insert bulge on the fill neck insert, wherein the fill neck insert assembles to the fill neck via an interference fit between the insert bulge and an inner diameter of the fill neck.

8. The fuel tank assembly of claim 1, further including an external thread on one of the the fill neck insert and and the fill neck; and a matching internal thread on the other of the fill neck insert and the fill neck.

9. The fuel tank assembly of claim 8, wherein the fill neck insert assembles to the fill neck via the external and matching internal threads.

10. The fuel tank assembly of claim 1, further including a tab on one of the fill neck insert and the fill neck; and a ridge on the other of the fill neck insert and the fill neck, the tab having a first tab side and a second tab side, the ridge having a first ridge side and a second ridge side, the first sides of the tab and ridge facing each other prior to final assembly of the fill neck assembly.

11. The fuel tank assembly of claim 10, wherein the fill neck insert assembles to the fill neck by pushing it into the fill neck until a resistance between the tab and the ridge is overcome and the second sides of the tab and ridge are facing one another.

12. A method of adjusting the fill capacity of a fuel tank having a tank body and a fill neck assembly, the fill neck assembly having a first end positioned outside of the tank body and a second end positioned inside of the tank body, the method comprising changing the location of the second end to adjust the fill capacity of the fuel tank.
